(19) United States
(12) Patent Application Publication
(10) Pub. No.: US 2016/0250550 A1
(43) Pub. Date: Sep. 1, 2016

(54) INFORMATION PROCESSOR, MESSAGE DISPLAY METHOD, INFORMATION SYSTEM, AND PROGRAM

(71) Applicant: Sony Computer Entertainment Inc., Tokyo (JP)

(72) Inventors: Masanori NOMURA, Tokyo (JP); Shigetaka KUDO, Tokyo (JP)

(21) Appl. No.: 15/042,809

(22) Filed: Feb. 12, 2016

(30) Foreign Application Priority Data
Feb. 27, 2015 (JP) 2015-038524

(51) Int. Cl. A63F 13/34; A63F 13/87

(52) U.S. Cl. CPC A63F 13/34; A63F 13/87

(57) ABSTRACT

Disclosed herein is an information processor including: an acquisition section adapted to acquire, from other information processor, information about a connection status between the information processors; and a message processing section adapted to display a message on the basis of the connection status information. The connection status information includes information about a communication environment of the other information processor, and the message processing section displays a message about the communication environment of the other information processor.

### BACKGROUND

The present disclosure relates to a technology for connecting two information processors via a network.

Recent years have seen user terminals that can connect to each other via peer to peer (P2P) for direct communication. Japanese Patent Laid-Open No, 2012-34793 proposes a game delivery system in which a delivering game device delivers information about a game playing status to a receiving game device so that the receiving user can join a game being executed in the delivering game device.

### SUMMARY

In the case of communication between two information processors over the Internet, one important factor for determining whether or not data can be exchanged is communication speed. For example, if one of the information processors delivers game image data to the other information processor, and if the other information processor plays the game on the basis of the delivered game image data, it is difficult for the users to play the game to their hearts' content in the event of a large communication latency. Therefore, the connection status between the two should preferably be grasped prior to delivery of game image data, and that game image data should preferably not be delivered at all from the beginning if it is clear that the communication condition is poor due, for example, to an insufficient communication speed.

In that case, the user is notified that it is difficult to deliver images due to a poor communication condition. However, receiving a notice alone does not allow the user to know why the communication condition is poor. In light of the foregoing, it is desirable to provide users with useful information in the event of a poor communication condition in an information system designed to connect two information processors over a network.

According to an embodiment of the present disclosure, there is provided an information processor. The information processor includes an acquisition section and a message processing section. The acquisition section acquires, from an other information processor, information about a connection status between the information processors. The message processing section displays a message on a basis of the connection status information. The connection status information includes information about a communication environment of the other information processor. The message processing section displays a message about the communication environment of the other information processor.

According to another embodiment of the present disclosure, there is provided an information system for connecting first and second information processors. The first information processor includes an acquisition section and a message processing section. The acquisition section acquires information about a connection status between the first and second information processors. The message processing section displays a message on a basis of the connection status information. The connection status information includes information about a communication environment of the second information processor. The message processing section displays a message about the communication environment of the second information processor.

According to further another embodiment of the present disclosure, there is provided a message display method for displaying a message on an information processor. The message display method includes: acquiring, from an other information processor, information about a connection status between the information processors; and displaying a message on a basis of the connection status information. The connection status information includes information about a communication environment of the other information processor, and the displaying displays a message about the communication environment of the other information processor.

According to further another embodiment of the present disclosure, there is provided a program for a computer, including: acquiring, from an other computer, information about a connection status between the computers; and displaying a message on a basis of the connection status information. The connection status information includes information about a communication environment of the other computer, and the displaying displays a message about the communication environment of the other computer.

It should be noted that any combinations of the above components and any conversions of expressions of the present disclosure between method, device (processor), system, recording medium, computer program, and so on are also effective as modes of the present disclosure.

The present disclosure provides users with useful information in the event of a poor communication condition in an information system designed to connect two information processors.

### BRIEF DESCRIPTION OF THE DRAWINGS

FIG. 1 is a diagram illustrating an information system according to an embodiment of the present disclosure;

FIG. 2 is a diagram illustrating functional blocks of an information processor;

FIG. 3 is a diagram illustrating configurations of information processors of host and guest users;

FIG. 4 is a diagram illustrating a chat room member screen;

FIG. 5 is a diagram illustrating a Share Play start screen;

FIG. 6 is a diagram illustrating a chat room member screen;

FIG. 7 is a diagram illustrating a chat room member screen that appears;

FIG. 8 is a diagram illustrating examples of messages retained;

FIG. 9 is a diagram illustrating an error screen; and

FIG. 10 is a diagram illustrating a screen showing an action message.

### DETAILED DESCRIPTION OF THE PREFERRED EMBODIMENT

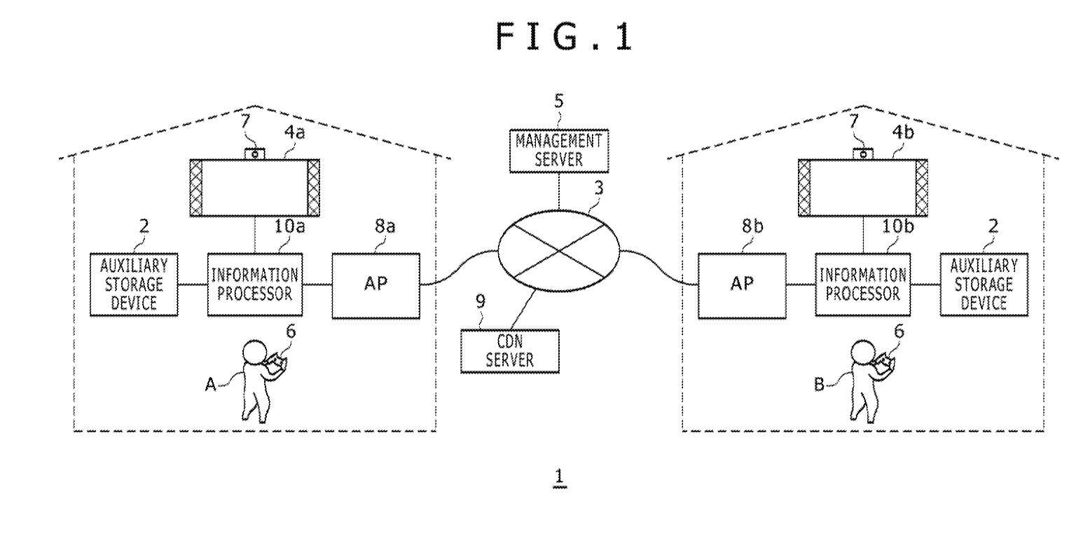

FIG. 1 illustrates an information system 1 according to an embodiment of the present disclosure. The information system 1 includes information processors 10a and 10b, a management server 5, and a contents delivery network (CDN) server 9. The information processors 10a and 10b are operated respectively by users A and B (hereinafter referred to as “information processors 10” unless a specific distinction is made therebetween). These devices are connected via a network 3 such as the Internet or a local area network (LAN). It should be noted that although only the two information processors 10 are shown in FIG. 1, a large number of information processors 10 around the world are actually connected to the network 3. Each of access points 8a and 8b (hereinafter referred to as “APs 8” unless a specific distinction is made therebetween) has a wireless access point function and a router function. Each of the information processors 10 connects to one of the APs 8 through a wireless LAN or a wired connection for communication with the management server 5 or the information processors 10 operated by other users on the network 3.

Each of the information processors 10 connects to an input device 6 operated by one of the users in a wireless or wired manner. The input device 6 provides the information processor 10 with operation information showing user operation results. When each of the information processors 10 receives operation information from the input device 6, the information processor 10 reflects the information in the processing of system and application software, causing one of output devices 4a and 4b thereinafter referred to as “output devices 4” unless a specific distinction is made therebetween) to output processing results. In the information system 1, each of the information processors 10 is a game device adapted to execute a game, and each of the input devices 6 may supply user operation information to the information processor 10 such as game controller.

In an excellent communication environment, the information processor 10a of one user connects to the information processor 10b of other user via P2P and delivers image data of a game being played by streaming. As described above, the information system 1 functions as a game image delivery system. The information processors 10a and 10b may be game devices of the same type. Alternatively, the information processors 10a and 10b may be game devices of different types. Further, the information processor 10b adapted to receive the delivery of game image data may be a mobile device such as smartphone or tablet.

An auxiliary storage device 2 is a large-capacity storage device such as hard disc drive (HDD) or flash memory. The auxiliary storage device 2 may be an external storage device adapted to connect to the information processors 10 through universal serial bus (USB). Alternatively, the auxiliary storage device 2 may be a built-in storage device. Each of the output devices 4 may be a television set having a display adapted to output image and a speaker adapted to produce audio. Alternatively, each of the output devices 4 may be a computer display. The output devices 4 may be connected to the information processors 10 by cables or wirelessly.

Each of the input devices 6 includes a plurality of input sections such as a plurality of push-type operation buttons, an analog stick used to enter an analog quantity, and a rotating button. A camera 7, an imaging device, is provided close to the output device 4 to capture an image of the surrounding space. Although FIG. 1 shows an example in which the camera 7 is attached to the top portion of the output device 4, the camera 7 may be arranged on a lateral side of the output device 4. In any case, the camera 7 is arranged where it can capture an image of the user playing game in front of the output device 4. It should be noted that the camera 7 may be a stereo camera.

In the information system 1, the information processors 10a and 10b allow the users A and B to start a chat application and enter the same chat room and chat with each other, respectively. In the information system 1, if the information processor 10 of a user (host user) is connected to that of other user (guest user) via P2P communication while the users chat with each other, a game image of the host user is shared. For example, if a game image of the user A are delivered from the information processor 10a to the information processor 10b while the user A plays a game, the user B can view the game image of the user A.

The management server 5 provides a game network service to users of the information system 1. The management server 5 manages network accounts adapted to identify users. Each user signs into the network service provided by the management server 5 using a network account. As the user signs into the network service from the information processor 10, he or she can register the saved data of the game and virtual trophies acquired while playing the game with the management server 5. For communication between the information processor 10 with the other information processor 10 in the embodiment, it is a prerequisite for the user to sign into the management server 5. The user can chat and share content images with other users for the first time by signing into the management server 5.

The CDN server 9 is designed to build an optimized network for delivering content over the Internet. The CDN server 9 shown in FIG. 1 represents the first transit server for the information processor 10a to deliver image data.

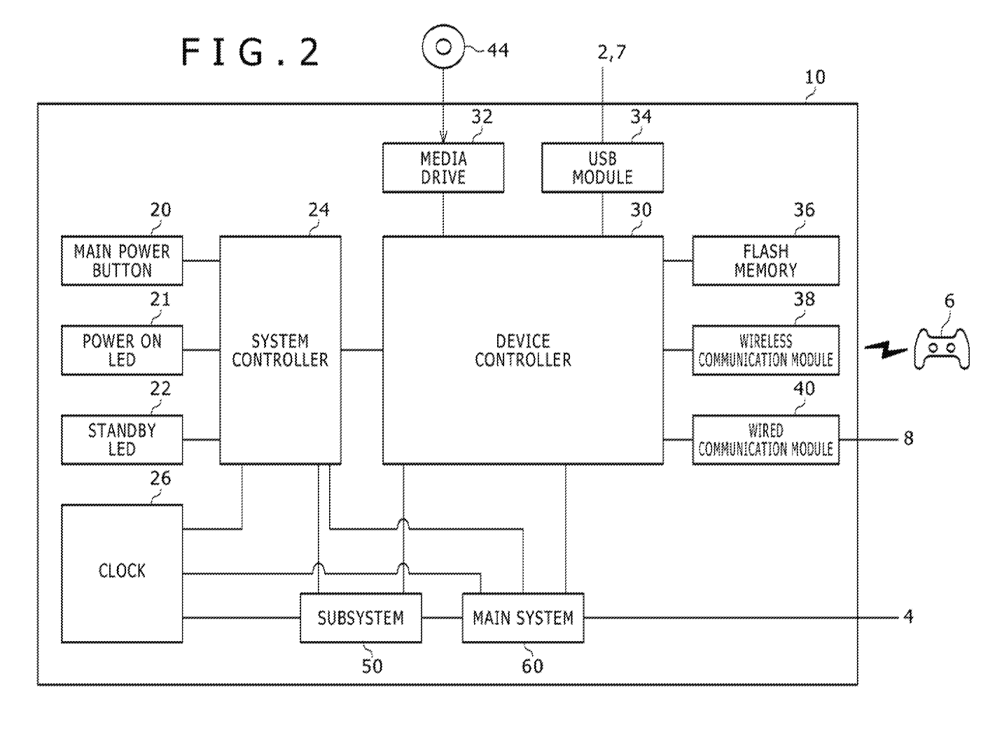

FIG. 2 illustrates a functional block diagram of the information processor 10. The information processor 10 includes a main power button 20, a power ON light-emitting diode (LED) 21, a standby LED 22, a system controller 24, a clock 26, a device controller 30, a media drive 32, a USB module 34, a flash memory 36, a wireless communication module 38, a wired communication module 40, a subsystem 50, and a main system 60.

The main system. 60 includes a main central processing unit (CPU), a memory, i.e., a main storage device, a memory controller, a graphics processing unit (GPU), and so on. The GPU is used primarily for arithmetic operations in game programs. These functions may be configured as a system-on-chip and formed on a single chip. The main CPU has a function to execute game programs recorded in the auxiliary storage device 2.

The subsystem 50 includes a sub CPU, a memory, i.e., a main storage device, and a memory controller, but not a GPU. As a result, the subsystem 50 does not have a function to execute game programs. The circuit gate count of the sub CPU is smaller than that of the main CPU, and the sub CPU consumes less power during operation than the main CPU. The sub CPU remains operational even when the main CPU is on standby, with the processing capability thereof being limited for minimal power consumption.

The main power button 20 is an input section for the user to make an operation input. The main power button 20 is provided on the front face of the enclosure of the information processor 10 and is operated to turn ON or OFF the power for the main system 60 of the information processor 10. The power ON LED 21 lights up when the main power button 20 is switched ON. The standby LED 22 lights up when the main power button 20 is switched OFF.

The system controller 24 detects the pressing of the main power button 20 by the user. If the main power button 20 is pressed when the main power is OFF, the system controller 24 acquires the pressing as a “switch-ON instruction.” On the other hand, if the main power button 20 is pressed when the main power is ON, the system controller 24 acquires the pressing as a “switch-OFF instruction.”

The clock 26 is a real-time clock adapted to create current date/time information and supplies this information to the system controller 24, the subsystem 50, and the main system 60. The device controller 30 is configured as a large-scale integrated circuit (LSI) adapted to transfer information between devices as does a southbridge. As illustrated in FIG. 2, the system controller 24, the media drive 32, the USB module 34, the flash memory 36, the wireless communication module 38, the wired communication module 40, the subsystem 50, and the main system 60, and other devices are connected to the device controller 30. The device controller 30 accommodates the differences in electrical characteristic and data transfer rate, thus controlling the data transfer timings.

The media drive 32 is a drive device which receives a read-only memory (ROM) medium 44 that stores application software such as game and license information, driving the ROM medium 44 and reading the program and data therefrom. The ROM medium 44 is a read-only recording medium such as optical disc, magneto-optical disc, or Blu-ray disc.

The USB module 34 is a module connected to external equipment by a USB cable. The USB module 34 may be connected to the auxiliary storage device 2 and the camera 7 by a USB cable. The flash memory 36 is an auxiliary storage device that makes up an internal storage. The wireless communication module 38 communicates wirelessly, for example, with the input device 6 using a communication protocol such as Bluetooth (registered trademark) protocol or IEEE802.11 protocol. It should be noted that the wireless communication module 38 may support the third generation digital mobile phone system compliant with the international mobile telecommunication 2000 (IMT-2000) standard defined by the international telecommunication union (ITU). Further, the wireless communication module 38 may support a digital mobile phone system of other generation. The wired communication module 40 communicates with external equipment in a wired manner, connecting to the network 3 via the AP 8.

In the information system 1 of the embodiment, a plurality of users enter a chat room to engage in text chat or voice chat for communication with each other. One of the users declares to share game images with other user. The sharing of game images will be hereinafter referred to as “Share Play.” Other user announces that he or she will join Share Play, and if the user who made the declaration approves the participation of the other user, the information processors 10 of the two users are connected via P2P communication for delivery of game images. In Share Play, the user who delivers game images is referred to as a “host” or “host user,” and the user who receives the delivery of game images as a “guest” or “guest user.”

The following three modes of Share Play are available:

The first mode of Share Play is called “Share Screen” in which the host user shares game images with the guest user, and the guest user views game images.

The second mode of Share Play is called “Hand over my controller” in which the host user shares game images with the guest user, and at the same time, the guest user handles game operations in place of the host user.

The third mode of Share Play is “Hand over another controller” in which the host user shares game images with the guest user, and at the same time, the guest user joins Share Play as a new player to play a game with the host user.

In any mode of Share Play, game image data is delivered from the information processor 10 of the host user to that of the guest user. Therefore, it is necessary for the information processors 10 of the host and guest users to be connected at a high communication speed as a condition for Share Play to prevent any latency in game image data delivery. As a result, in the embodiment, it is verified whether the information processors 10 are properly connected for Share Play before starting Share Play.

A description will be given below of the operation of the information processor 10a when the user A declares the beginning of Share Play as a host user, and the user B joins Share Play as a guest user.

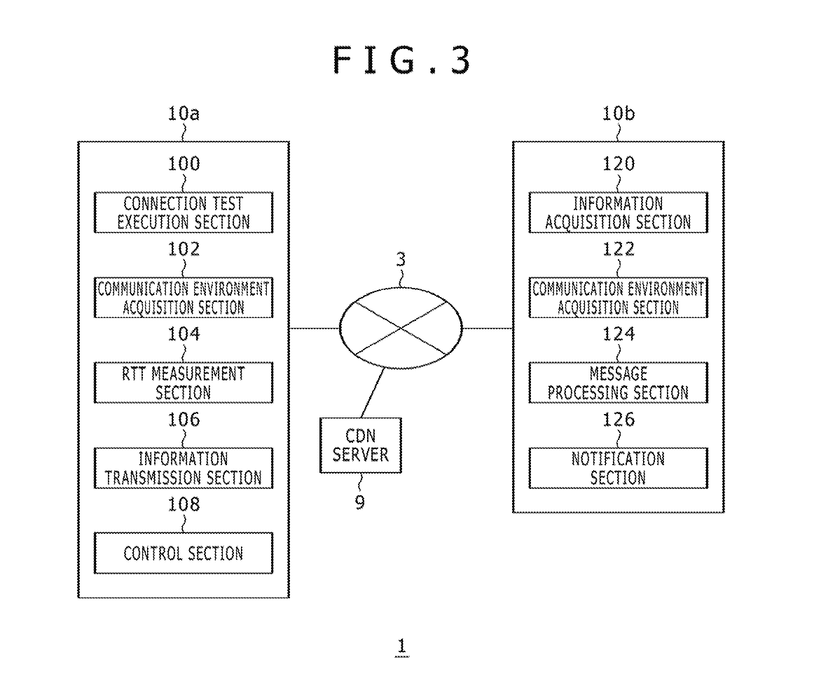

FIG. 3 illustrates configurations of the information processors 10a and 10b of the host and guest users. The information processor 10a includes a connection test execution section 100, a communication environment acquisition section 102, a round trip time (RTT) measurement section 104, an information transmission section 106, and a control section 108. The information processor 10b includes an information acquisition section 120, a communication environment acquisition section 122, a message processing section 124, and a notification section 126. It should be noted that the configuration of the information processor 10a shown in FIG. 3 is that for acting as a host in Share Play, and that the configuration of the information processor 10b is that for acting as a guest in Share Play. In the information system 1, the information processor 10 can act both as a host and as a guest. Therefore, the information processor 10 has all the functions listed in FIG. 3.

In FIG. 3, each of the components described as functional blocks adapted to perform a variety of processing tasks can be configured with circuit blocks, memories, and other LSIs in terms of hardware, and by a program loaded into the memory in terms of software. Therefore, it is understood by those skilled in the art that these functional blocks can be implemented in a variety of ways by hardware alone, software alone, or by a combination thereof and are not limited to any one of them.

For the user A to become a host user for Share Play, it is necessary for a plurality of users including the user A to be in the same chat room.

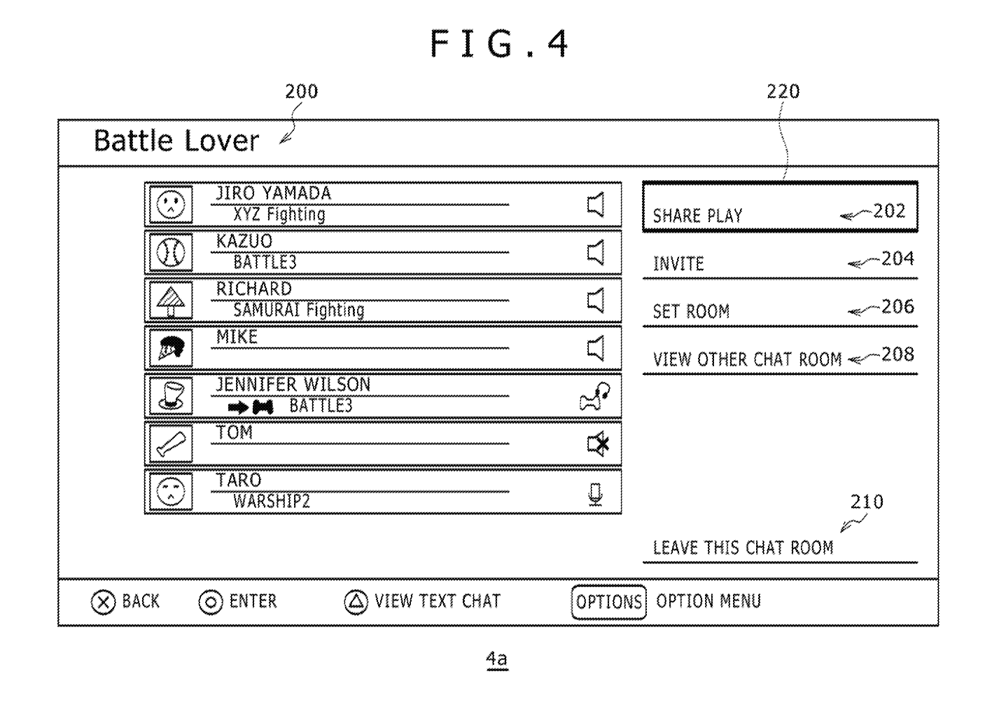

FIG. 4 illustrates an example of a chat room member screen that appears on the output device 4a. A room name 200 appears at the upper area of the member screen. Not only user information about the user himself or herself but also that about other users in the chat room appears on the left side of the member screen. It should be noted that user information of the user A appears at the lowermost area, showing that the user name is “TARO,” and that the game titled “WARSHIP2” is being played. At this Lame, seven users including the user A (TARO) participate in chat room “Battle Lover.”

The function items of the chat room appear on the right side of the member screen. A Share Play item 202 is designed for a user to declare that he or she will become a Share Play host user. An Invite item 204 is designed to invite other user into the chat room. A Set Room item 206 is designed to adjust the microphone level, audio mix, and other settings for the chat. Further, a View Other Room item 208 is designed to view other chat rooms. A Leave item 210 is designed to leave this chat room.

In the member screen, a focus frame 220 appears in such a manner that it can be moved, thus allowing the user A to operate the input device 6 and select a desired item. In the example shown in FIG. 4, the focus frame 220 is located on the Share Play item 202. When the user A operates the enter button of the input device 6 with the focus frame 220 placed on the Share Play item 202, a Share Play start screen appears on the output device 4a.

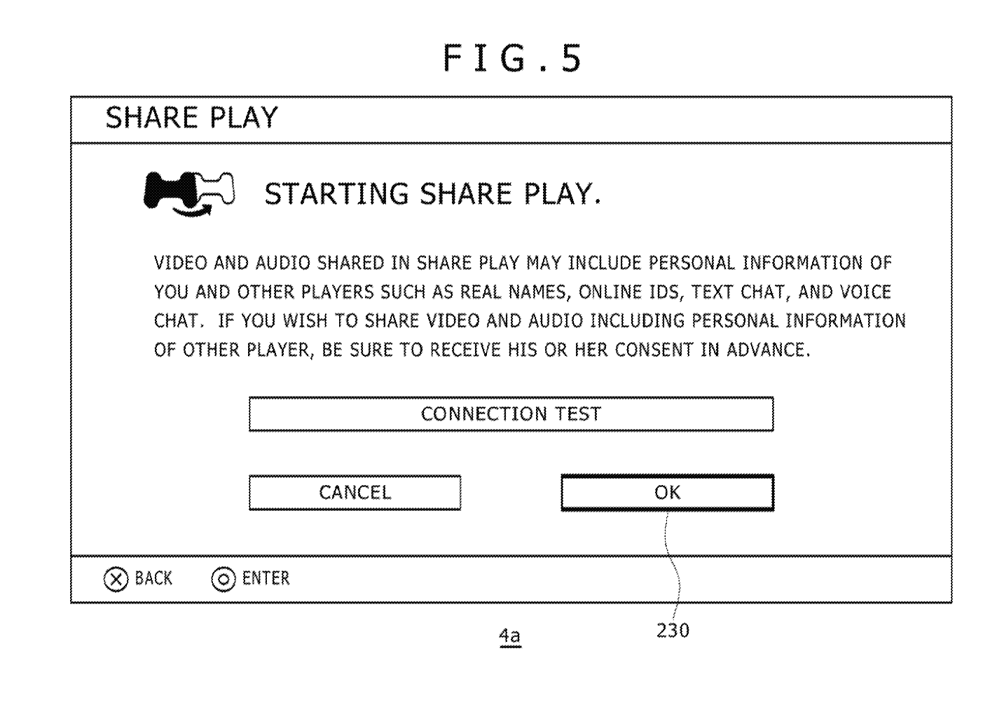

FIG. 5 illustrates a Share Play start screen that appears on the output device 4a. The start screen shows a caution about Share Play.

When the user A becomes a host user, the information processor 10a delivers game image data to the information processors 10 of the guest users. Therefore, it is necessary for the information processor 10a to have a sufficiently high upload speed. If the communication speed is low, it is difficult to engage in Share Play properly. For this reason, the information processor 10a has a function to automatically self-diagnose its own communication speed with the Share Play start screen on screen.

More specifically, the connection test execution section 100 performs an upload speed connection test with the CDN server 9. During the test, a display area that reads “Connection Test” in the Share Play start screen may flash, for example, to inform the user A that a connection test is automatically under way in the background.

The connection test execution section 100 determines that sufficiently high speed communication is possible if the upload speed is 5 Mbps (megabits per second) or more. Further, the connection test execution section 100 determines that high speed communication is possible if the upload speed is 2 Mbps or more although the upload speed is less than 5 Mbps. If it is determined that high speed communication is possible, the display area that reads “Connection Test” stops flashing. When the user A moves a focus frame 230 to select the “OK” button, he or she can become a Share Play host user. It should be noted that if the upload speed is less than 2 Mbps, the user A may be informed that although the communication environment basically permits Share Play, there is a likelihood that a poor communication condition may arise.

On the other hand, the connection test execution section 100 determines that the upload speed is insufficient for Share Play if the speed is less than 2 Mbps. At this time, the control section. 108 shows, on the output device 4a, that it is difficult for the user A to become a host user. As described above, it is difficult for the user A to become a host user unless high speed communication is available with the information processor 10a.

It should be note that the connection test execution section 100 may skip the connection test this time so long as it was found as a result of the previous connection test that an upload speed of 5 Mbps or more is available.

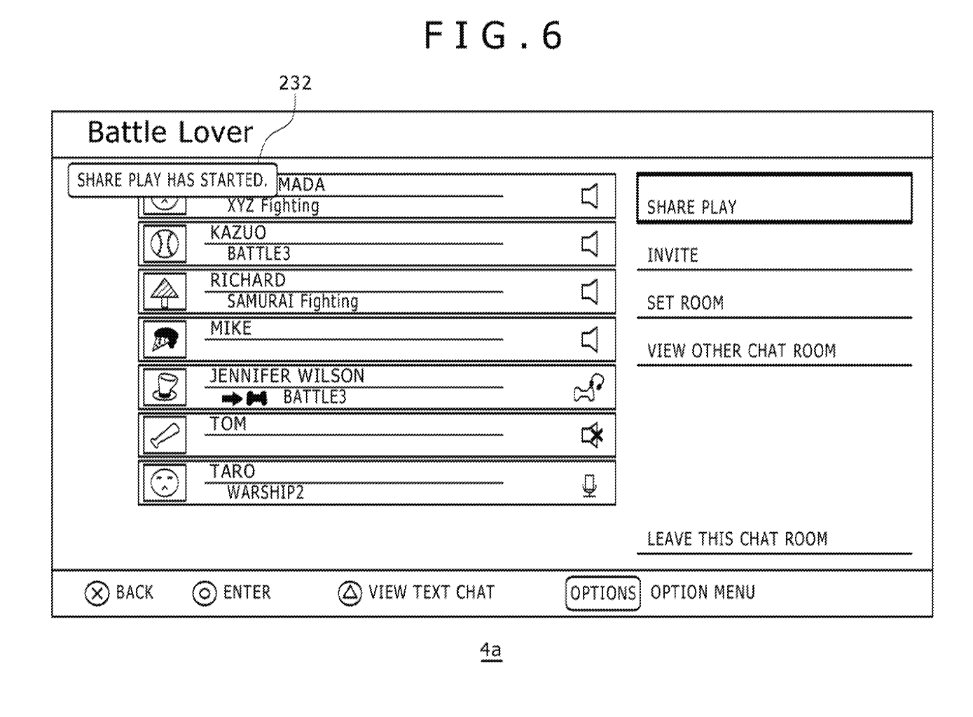

FIG. 6 illustrates a chat room member screen that appears on the output device 4a. The control section 108 displays a start message 232 on the member screen to show that the Share Play start condition has been met. The start message 232 may appear, for example, for several seconds after the screen is switched from the Share Play start screen over to the member screen, and then disappear afterwards. Further, the control section 108 sends, to the “Battle Lover” members, i.e., other members participating in the same chat room, a message to the effect that the user A has started Share Play. This allows the other members to know that the user A has started Share Play. It should be noted that Share Play is started here for the first time when other users are given permission to participate. Therefore, a message showing that the user A has started Share Play means that the user A wishes to proceed with Share Play and is waiting for other users to participate.

A description will be given next of the operation when the user B declares that he or she will join Share Play in which the user A is a host. Here, the user B is “RICHARD” and displays the chat room member screen on the output device 4b.

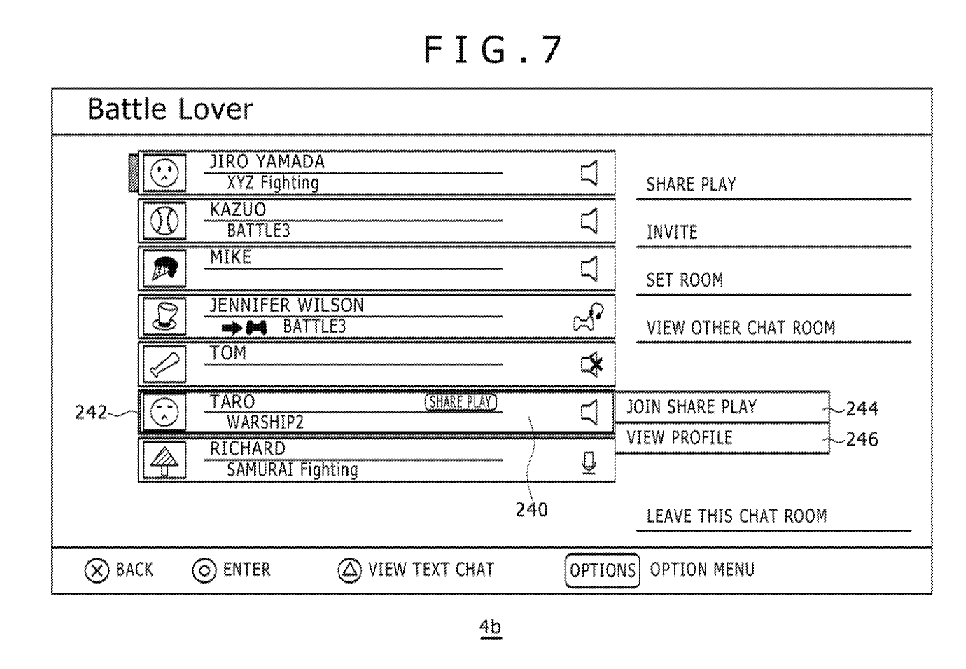

FIG. 7 illustrates an example of a chat room member screen that appears on the output device 4b. A Share Play indicator appears in an information display column 240 of TARO, the user A, to show that he can join Share Play. The user B recognizes that “TARO,” the user A, can join Share Play by checking the Share Play indicator.

When a focus frame 242 is placed on the information display column 240 of the user A (TARO), a Join graphical user interface (GUI) 244 and a Profile GUI 246 appear. The Join GUI 244 is used to select the participation in Share Play. The Profile GUI 246 is used to select the viewing of the profile of “TARO.” As the user B places the focus frame 242 on the Join GUI 244 and operates the enter button, the information processor 10b transmits a request for participation to the information processor 10a apply the participation in user A's Share Play.

In Share Play, the information processors 10a and 10b are connected via P2P communication. For that purpose, it is necessary for the information processors 10a and 10b to be able to communicate with low latency. When the information processor 10a receives a request for participation from the information processor 10b, the information processor 10a conducts a connection test with the information processor 10b. This test is accomplished by the RTT measurement section 104 measuring the RTT. The RTT measurement section 104 may measure the RTT by a known method.

The control section 108 determines whether or not the communication speed is high on the basis of the RTT measured by the RTT measurement section 104. The control section 108 may determine whether the measured RTT is excellent or poor by comparing the RTT against a given threshold. If the communication speed is sufficiently high, the control section. 108 approves the participation of the user B, thus initiating Share Play between the users A and B.

On the other hand, if the control section 108 determines that the communication speed is not high enough for Share Play on the basis of the RTT measured by the RTT measurement section 104, the control section 108 sends, to the information processor 10b, an error message to the effect that Share Play is not possible because of a low communication speed. The information processor 10b acquires the error message and displays the message on the output device 4b, notifying the user B that Share Play with the user A is not possible.

At this time, even if the information processor 10b simply shows “It is difficult to join Share Play at present because of low Internet communication speed” on the output device 4b as a result of connection test of the information processor 10a, it is difficult for the user B to know why it has been determined that the communication condition is poor. Because it is difficult for the user B to even know whether Share Play is accidentally not possible with the user A or whether Share Play is not possible with all the users, the user B's motivation for Share Play may decline. Therefore, if there is any possible action the user B can take, he or she should preferably be notified of that action.

Even in that case, it is likely that even if all information about possible actions available as templates is notified, there may be too much information for the user B to be useful. For this reason, information presented to the user B should preferably be narrowed down to match the communication environments of the information processors 10a and 10b.

When sending an error message, the information processor 10a also transmits information about the connection status between the information processors 10a and 10b. Information about the connection status includes the measured RTT, the upload speed detected as a result of the connection test with the CDN server 9, and information about the communication environment of the information processor 10a. Here, information about the communication environment of the information processor 10a includes, for example, information showing whether the information processor 10a is connected to the AP 8a in a wired manner or through a wireless LAN. The communication environment acquisition section 102 detects whether the information processor 10a is connected to the AP 8a by a LAN cable or through a wireless LAN, thus acquiring this detection result as information about the communication environment. When the communication condition is poor, the information transmission section 106 transmits, to the information processor 10b, information about the connection status between the information processors together with an error message.

In the information processor 10b, the information acquisition section 120 acquires error messages and connection status information. It should be noted that the communication environment acquisition section 122 acquires information about the communication environment of the information processor 10b. Here, communication environment information includes information about whether the information processor 10b is connected to the AP 8b in a wired manner or through a wireless LAN.

The message processing section 124 displays, on the output device 4b, information that serves as a tip to solve the poor communication condition on the basis of connection status information acquired by the information acquisition section 120. At this time, the message processing section 124 also displays a message about the communication environment of the information processor 10a.

The message processing section. 124 has a plurality of message templates and selects a message to display on the basis of connection status information.

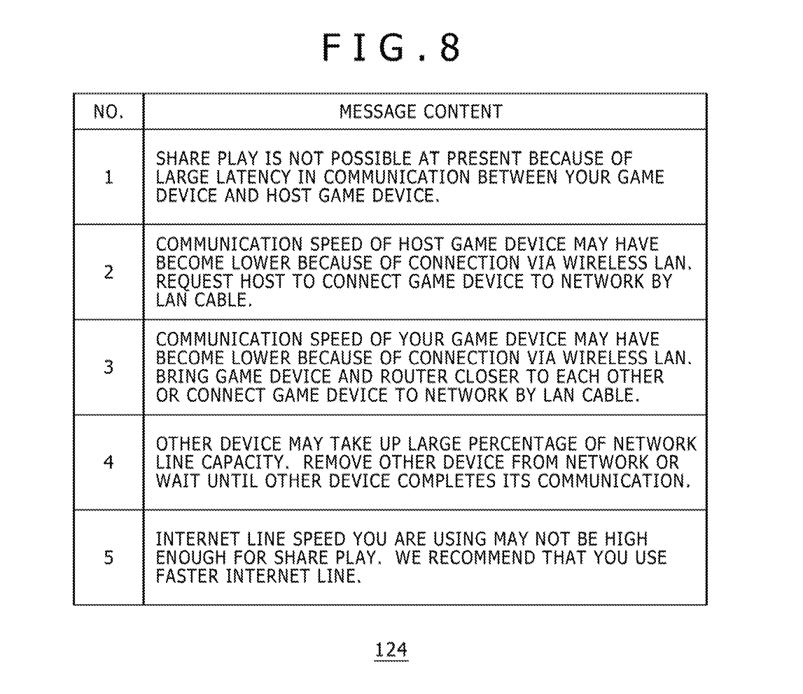

FIG. 8 illustrates examples of messages retained. In this example, the message processing section 124 has five messages. When the information acquisition section 120 acquires connection status information from the information processor 10a, the message processing section 124 selects a message that matches the connection status information from among the plurality of messages retained.

The message numbers and the conditions for displaying the messages are listed below.

Message No. 1 is displayed when the RTT measured by the information processor 10a is greater than a given value.

Message No. 2 is displayed when the information processor 10a is connected to the AP 8a through a wireless LAN.

Message No. 3 is displayed when the information processor 10b is connected to the AP 8b through a wireless LAN.

Message Nos. 4 and 5 typically appear.

There are conditions for displaying message Nos. 1 to 3. Filtering the messages under these conditions ensures that those messages that do not meet the conditions are not displayed, thus contributing to a reduced number of messages presented to the user B.

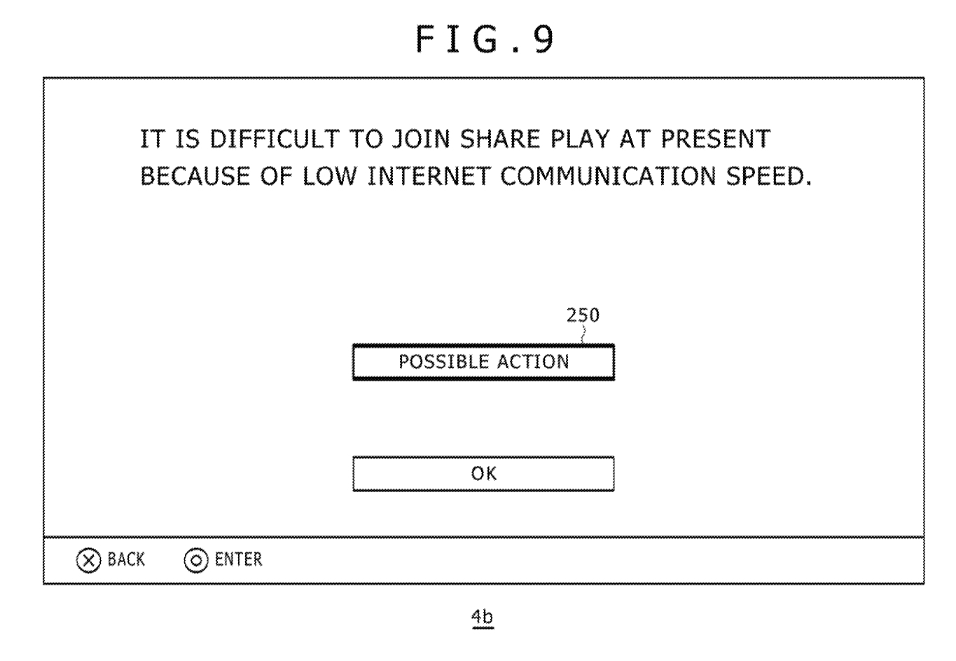

FIG. 9 illustrates an example of an error screen when the information acquisition section 120 receives an error message. The notification section 126 generates an error screen and notifies the user B that he or she has not participated in Share Play. When the user B places a focus frame 250 on “Possible Action” and operates the enter button, the message processing section 124 displays a message that matches the connection status information. We assume here that the information processor 10a is wirelessly connected to the AP 8a, and that the information processor 10b is connected to the AP 8b in a wired manner (by a LAN cable).

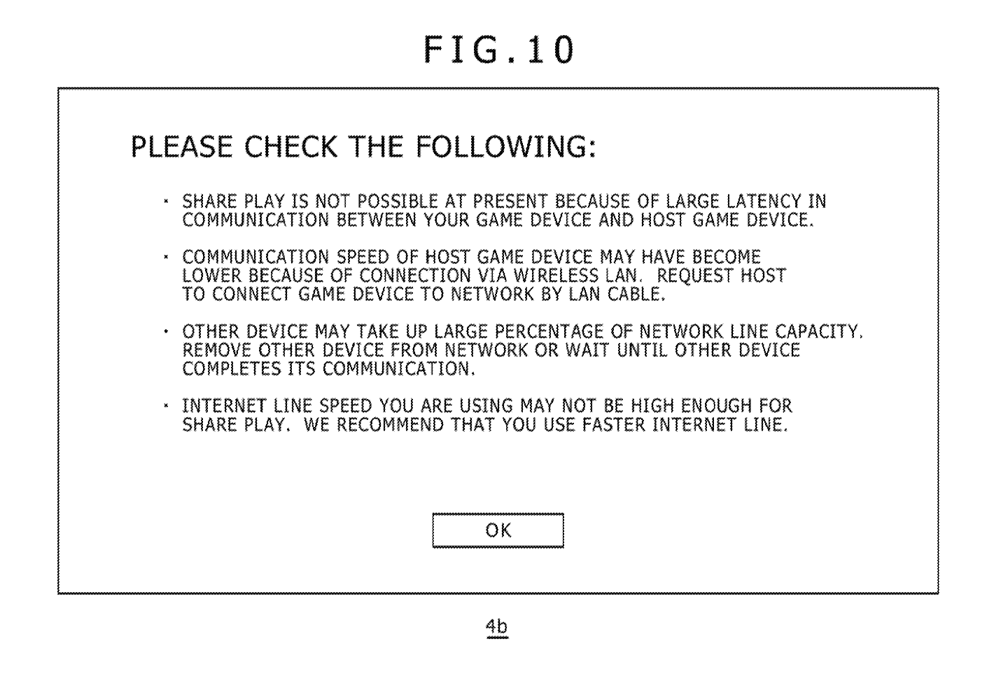

FIG. 10 illustrates an example of an action message display screen. In this example, the message processing section 124 displays message Nos. 1, 2, 4, and 5 of the five messages retained. As described above, the message processing section 124 presents, to the user B, only those messages that fit the connection status between the information processors 10a and 10b rather than presenting, to the user B, all the message retained. If the information processor 10b is already connected to the AP 8b in a wired manner, message No. 3 does not serve as a tip to eliminate the poor communication condition. Therefore, message No. 3 does not appear in the example shown in FIG. 10.

As illustrated in FIG. 10, the second message from the top (message No. 2) relates to the communication environment of the information processor 10a side of the host. By indicating, to the user B, that the poor communication condition may have been attributable to the circumstance of the user A, i.e., the communication environment of the information processor 10a, it is possible for the user B to become aware that he or she may not be the one to blame for the poor communication condition. It should be noted that because, in the embodiment, the users A and B can communicate with each other by chatting, the user B may request the user A to switch over to connection using a LAN cable in response to the message.

Thus, an embodiment of the present disclosure has been described above. It should be understood by those skilled in the art that the above embodiment is illustrative, that the combination of components and processes can be modified in various ways, and that such modification examples also fall within the scope of the present disclosure.

The information processor 10b adapted to receive the delivery of game image data may be a game device of the same type as the information processor 10a. Alternatively, the information processor 10b may be a terminal device of other type. In that case, the message processing section 124 of the information processor 10b should preferably have message templates appropriate to the type of the terminal device and select a proper message on the basis of connection status information transmitted from the information processor 10a for presentation to the user B.

Further, if a poor communication condition arises between the information processors 10a and 10b during Share Play, the message processing section 124 should preferably display a message on the output device 4b on the basis of connection status information acquired by the information acquisition section 120 before Share Play begins.

The present disclosure contains subject matter related to that disclosed in Japanese Priority Patent Application JP 2015-038524 filed in the Japan Patent Office on Feb. 27, 2015, the entire content of which is hereby incorporated by reference.

What is claimed is:

1. An information processor comprising:
an acquisition section adapted to acquire, from an other information processor, information about a connection status between the information processors; and
a message processing section adapted to display a message on a basis of the connection status information,
wherein the connection status information includes information about a communication environment of the other information processor, and
the message processing section displays a message about the communication environment of the other information processor.

2. The information processor of claim 1,
wherein the message processing section has a plurality of messages and selects a message to display on the basis of the connection status information.

3. The information processor or claim 1,
wherein the message processing section displays a message if a communication condition is poor between the information processors, and
the message about the communication environment indicates that the other information processor is connected through a wireless local area network.

4. An information system for connecting first and second information processors,
wherein the first information processor includes:
an acquisition section adapted to acquire information about a connection status between the first and second information processors; and
a message processing section adapted to display a message on a basis of the connection status information,
the connection status information includes information about a communication environment of the second information processor, and
the message processing section displays a message about the communication environment of the second information processor.

5. A message display method for displaying a message on an information processor, the message display method comprising:
acquiring, from an other information processor, information about a connection status between the information processors; and
displaying a message on a basis of the connection status information,
wherein the connection status information includes information about a communication environment of the other information processor, and
the displaying displays a message about the communication environment of the other information processor.

6. A program for a computer, comprising:
acquiring, from an other computer, information about a connection status between the computers; and
displaying a message on a basis of the connection status information,
wherein the connection status information includes information about a communication environment of the other computer, and
the displaying displays a message about the communication environment of the other computer.
